(19) United States
(12) Patent Application Publication
(10) Pub. No.: US 2017/0152908 A1
(43) Pub. Date: Jun. 1, 2017

(54) TUBULAR VIBRATION-DAMPING DEVICE

(71) Applicant: SUMITOMO RIKO COMPANY LIMITED, Komaki-shi (JP)

(72) Inventor: Yuki YAHATA, Komaki-shi (JP)

(73) Assignee: SUMITOMO RIKO COMPANY LIMITED, Komaki-shi (JP)

(21) Appl. No.: 15/134,685

(22) Filed: Apr. 21, 2016

(30) Foreign Application Priority Data
Dec. 1, 2015 (JP) 2015-235225

(51) Int. Cl. F16F 1/38; B60G 21/05

(52) U.S. Cl. CPC F16F 1/38; B60G 21/052; F16F 2230/36; B60G 2204/143; B60G 2204/41

(57) ABSTRACT

A tubular vibration-damping device including: an inner shaft member extending vertically; an outer tube member arranged so as to be externally about the inner shaft member; a connecting rubber elastic body elastically connecting the two members with each other; and a plurality of hollow parts formed in the connecting rubber elastic body so as to open onto an axially lower face thereof, at least one of the hollow parts being a drain hole penetrating through the connecting rubber elastic body vertically, wherein the hollow parts are formed at an odd number of locations which are not less than three and are positioned at regular intervals in a circumferential direction of the connecting rubber elastic body, and the hollow parts are arranged so as not to overlap mutually as viewed in a diametrical direction of the outer tube member.

### INCORPORATED BY REFERENCE

The disclosure of Japanese Patent Application No. 2015-235225 filed on Dec. 1, 2015 including the specification, drawings and abstract is incorporated herein by reference in its entirety.

### BACKGROUND OF THE INVENTION

1. Field of the Invention

The present invention relates to a tubular vibration-damping device used for an automotive member mount or the like that provides vibration damping linkage between a suspension member and a vehicle body, for example.

2. Description of the Related Art

Conventionally, tubular vibration-damping devices have been known as one type of vibration damping supports or vibration damping connecting components interposed between components that make up a vibration transmission system in order to provide vibration damping linkage between the components. As disclosed in Japanese Unexamined Patent Publication No. JP-A-H8-210407, for example, a tubular vibration-damping device has a structure including an inner shaft member, an outer tube member being externally about onto the inner shaft member, and a connecting rubber elastic body elastically connecting the inner shaft member and the outer tube member. In addition, as shown in JP-A-H8-210407, a tubular vibration-damping device such as a member mount that provides vibration damping linkage between an automotive suspension member and a vehicle body is used by being mounted onto a vehicle with its axial direction aligned with the vertical direction, in some instances.

Meanwhile, with regard to the tubular vibration-damping device used with its axial direction aligned with the vertical direction, since there is a risk that rainwater etc. may build up on the axially upper face thereof, a drainage structure such as a through hole is generally required. Accordingly, in JP-A-H8-210407, a pair of hollows vertically penetrating through the connecting rubber elastic body are formed, so that water etc. that builds up on the upper face of the connecting rubber elastic body is configured to be drained out downward through the hollows.

However, with the tubular vibration-damping device including the hollows (drain holes) as shown in JP-A-H8-210407, the spring constant becomes small due to decrease in the compression spring component of the connecting rubber elastic body in the diametrical direction in which the hollows are formed. Thus, while it is easy to set a large ratio between the spring constant in the diametrical direction in which the hollows are formed and the spring constant in the diametrical direction which is away from the hollows, it is difficult to set spring characteristics close to each other for those diametrical directions.

### SUMMARY OF THE INVENTION

It is therefore one object of this invention to provide a tubular vibration-damping device of novel structure which is able to prevent water etc. from building up on the upper face of the connecting rubber elastic body while reducing or avoiding variations in the diametrical spring constant of the connecting rubber elastic body along the circumferential direction.

The above and/or optional objects of this invention may be attained according to at least one of the following modes of the invention. The following modes and/or elements employed in each mode of the invention may be adopted at any possible optional combinations.

Specifically, a first mode of the present invention provides a tubular vibration-damping device comprising: an inner shaft member extending in a vertical direction; an outer tube member arranged so as to be externally about the inner shaft member; a connecting rubber elastic body elastically connecting the inner shaft member and the outer tube member with each other; and a plurality of hollow parts formed in the connecting rubber elastic body so as to open onto an axially lower face thereof, at least one of the hollow parts being a drain hole penetrating through the connecting rubber elastic body in the vertical direction, wherein the hollow parts are formed at an odd number of locations which are not less than three and are positioned at regular intervals in a circumferential direction of the connecting rubber elastic body, and the hollow parts are arranged so as not to overlap one another as viewed in a diametrical direction of the outer tube member.

With the tubular vibration-damping device of construction according to the first mode of the present invention, the rainwater etc. building up on the axially upper face of the connecting rubber elastic body will be eliminated through the drain hole, thereby improving durability or the like of the tubular vibration-damping device itself. Moreover, it is also possible to prevent the component to which the tubular vibration-damping device is mounted, such as a vehicle, from being corroded by the rainwater etc. building up on the connecting rubber elastic body.

Besides, at least one of the hollow parts, which are formed at an odd number of locations which are not less than three and are positioned at regular intervals in the circumferential direction of the connecting rubber elastic body, is a drain hole. Thus, the diametrical spring constant of the connecting rubber elastic body is prevented from becoming small locally at the circumferential portion where the drain hole is formed, whereby variations in the diametrical spring constant will be reduced along the circumferential direction. Furthermore, the hollow parts are arranged so as not to overlap one another as viewed in the diametrical direction of the outer tube member. Therefore, it is also possible to prevent the situation where, in the diametrical direction in which the hollow parts overlap each other, the diametrical spring constant of the connecting rubber elastic body becomes small locally at the specific circumferential portion, thereby more advantageously reducing variations in the diametrical spring constant along the circumferential direction.

A second mode of the present invention provides the tubular vibration-damping device according to the first mode wherein an axially upper face of the connecting rubber elastic body is a curving surface that extends with a concave cross section in the circumferential direction, and the drain hole opens onto a portion including an axially innermost part of the upper face of the connecting rubber elastic body.

According to the second mode, the rainwater etc. building up on the axially upper face of the connecting rubber elastic body will be led to the opening part of the drain hole positioned at the axially innermost part (lowest part) of the upper face of the connecting rubber elastic body due to the effect of gravity. Thus, the rainwater etc. will be efficiently drained out through the drain hole.

A third mode of the present invention provides the tubular vibration-damping device according to the first or second mode wherein the hollow parts entirely overlap the inner shaft member as viewed in the diametrical direction.

According to the third mode, adequate compression spring component of the connecting rubber elastic body is ensured in the diametrical direction in which the hollow parts are formed. Thus, the effect on the diametrical spring constant of the connecting rubber elastic body caused by the formation of the hollow parts will be reduced, thereby minimizing variations in the diametrical spring constant of the connecting rubber elastic body along the circumferential direction. In preferred practice, as viewed in the diametrical direction in which the hollow part is formed, the width of the hollow part is made smaller than the width of the inner shaft member. By so doing, with respect to the input in the diametrical direction in which the hollow part is positioned, the compression spring component of the connecting rubber elastic body predominates on the circumferentially opposite sides of the hollow part. This will minimize decrease in the diametrical spring constant of the connecting rubber elastic body.

A fourth mode of the present invention provides the tubular vibration-damping device according to any one of the first through third modes wherein all of the hollow parts are the drain holes penetrating through the connecting rubber elastic body in the vertical direction.

According to the fourth mode, all of the hollow parts formed in the connecting rubber elastic body at the plurality of locations in the circumferential direction are the drain holes. This makes it possible to more easily and advantageously reduce or avoid variations in the diametrical spring constant along the circumferential direction caused by the formation of the drain holes.

A fifth mode of the present invention provides the tubular vibration-damping device according to the fourth mode wherein the drain holes are identical in shape with one another.

According to the fifth mode, the drain holes formed at the plurality of locations in the circumferential direction of the connecting rubber elastic body are identical in shape with one another. Thus, it can be easy to set the diametrical spring constant of the connecting rubber elastic body to be generally constant. In addition, by setting the diametrical spring constant to be generally constant about the entire circumference of the connecting rubber elastic body, it will be unnecessary to determine the circumferential orientation of the tubular vibration-damping device during attachment to the mounting target such as a vehicle, thereby making the attachment easy.

A sixth mode of the present invention provides the tubular vibration-damping device according to any one of the first through fifth modes wherein the hollow parts are formed one by one at three locations positioned at regular intervals in the circumferential direction of the connecting rubber elastic body.

According to the sixth mode, with the minimum number of hollow parts, it is possible to reduce differences in the diametrical spring constant along the circumferential direction of the connecting rubber elastic body caused by the formation of the drain holes.

According to the present invention, rainwater etc. building up on the axially upper face of the connecting rubber elastic body will be drained out through the drain hole. This will improve durability or the like of the tubular vibration-damping device itself, the mounting target, and so forth. Moreover, the diametrical spring constant of the connecting rubber elastic body will be prevented from becoming small locally at the circumferential portion where the drain hole is formed, whereby variations (differences) in the diametrical spring constant can be minimized along the circumferential direction.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is a plan view showing a tubular vibration-damping device in the form of a member mount as a first embodiment of the present invention;

FIG. 2 is a bottom view of the member mount shown in FIG. 1;

FIG. 3 is a cross sectional view taken along line 3-3 of FIG. 1;

FIG. 4 is a vertical cross sectional view showing a state of the member mount shown in FIG. 1 being mounted to a vehicle;

FIG. 5 is a plan view showing a member mount as a second embodiment of the present invention;

FIG. 6 is a plan view showing a member mount as a third embodiment of the present invention;

FIG. 7 is a bottom view showing a member mount as a fourth embodiment of the present invention;

FIG. 8 is a cross sectional view taken along line 8-8 of FIG. 7;

FIG. 9 is a bottom view showing a member mount as a fifth embodiment of the present invention; and

FIG. 10 is a cross sectional view taken along line 10-10 of FIG. 9.

### DETAILED DESCRIPTION OF PREFERRED EMBODIMENTS

Embodiments of the present invention will be illustrated hereafter while referring to the drawings.

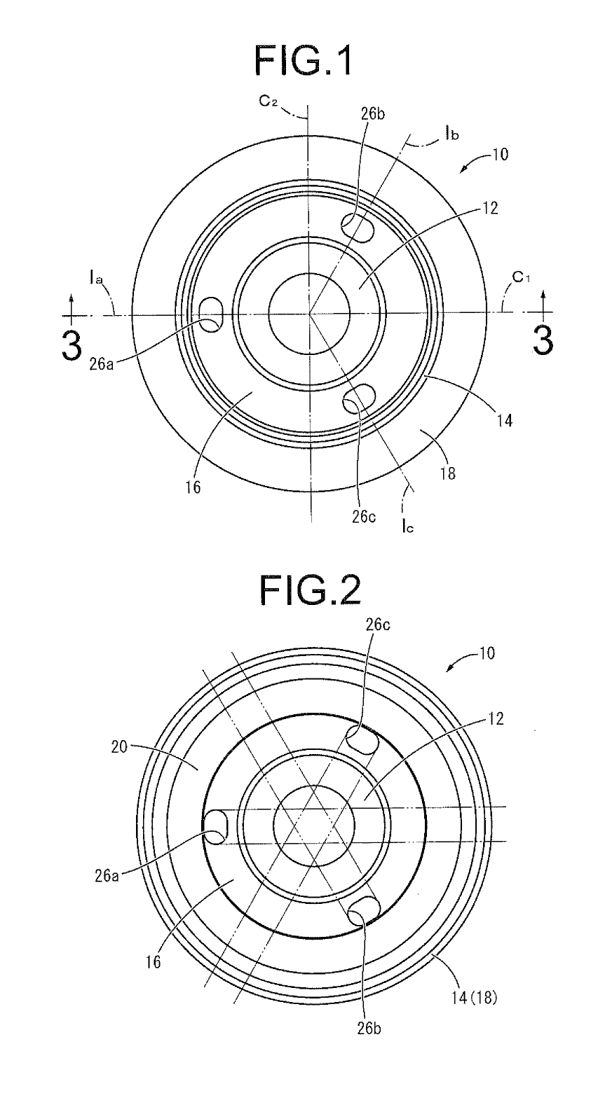

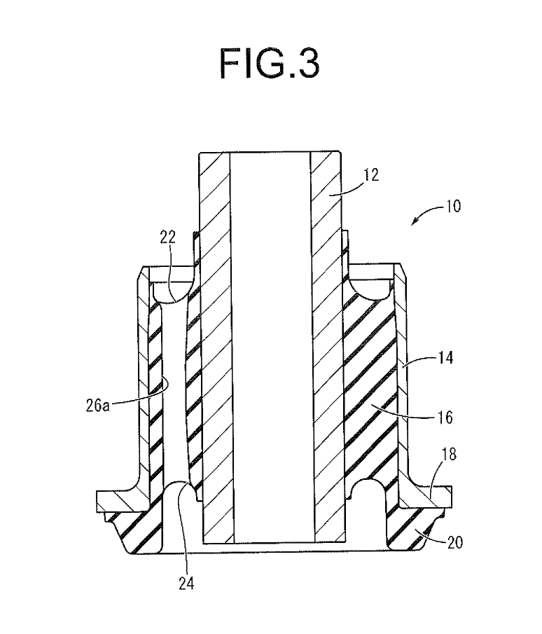

FIGS. 1 to 3 show an automotive member mount 10 as a first embodiment of a tubular vibration-damping device in a structure according to the present invention. The member mount 10 has a structure including an inner shaft member 12, an outer tube member 14 and a connecting rubber elastic body 16 elastically connecting the two members with each other. Note that in the explanation below, as a general rule, the vertical direction means the up and down direction in FIG. 3, which is roughly the vertical direction in a state of the member mount 10 being mounted to a vehicle. Also, the front and back direction and the left and right direction basically mean the up and down direction and the left and right direction in FIG. 1, respectively.

More specifically, the inner shaft member 12 is a member with high rigidity formed of a metal, a synthetic resin or the like, substantially in a shape of a circular tube with a small diameter extending in the vertical direction like a line.

The outer tube member 14 is a high rigidity member formed of the same material as that of the inner shaft member 12, which has a substantial shape of a circular tube with a large diameter as a whole, whose lower end is integrally provided with a flange part 18 protruding to the outer circumference.

The outer tube member 14 is externally about the inner shaft member 12 such that the inner shaft member 12 and the outer tube member 14 are arranged mutually on the same axis. The inner shaft member 12 and the outer tube member 14 are elastically connected with each other by the connecting rubber elastic body 16. The connecting rubber elastic body 16 is a rubber elastic body substantially in a thick circular tube shape, wherein the inner circumferential face thereof is bonded to the outer circumferential face of the inner shaft member 12 by vulcanization, while the outer circumferential face thereof is bonded to the inner circumferential face of the outer tube member 14 by vulcanization. The connecting rubber elastic body 16 of this embodiment is formed as an integrally vulcanization molded component including the inner shaft member 12 and the outer tube member 14.

Moreover, the connecting rubber elastic body 16 is provided with a stopper rubber 20 at the lower part of the outer circumferential end thereof. The stopper rubber 20 is formed integrally with the connecting rubber elastic body 16 and bonded by vulcanization to the lower face of the flange part 18 of the outer tube member 14 so as to protrude downward from the flange part 18.

Furthermore, an axially upper face 22 of the connecting rubber elastic body 16 is a curving surface that extends in the circumferential direction with a curving cross section in a concave shape opening upward. In the present embodiment, the upper face 22 has a roughly fixed cross sectional shape continuous across the entire circumference. In the same way, an axially lower face 24 of the connecting rubber elastic body 16 is a curving surface that extends in the circumferential direction with a curving cross section in a concave shape opening downward. In this embodiment, the lower face 24 has a roughly fixed cross sectional shape continuous across the entire circumference.

Also, in the connecting rubber elastic body 16, three hollow parts 26a, 26b, 26c are formed as shown in FIGS. 1 and 2. The hollow parts 26a, 26b, 26c open at least onto the lower face 24 of the connecting rubber elastic body 16. In this embodiment, all of the hollow parts 26a, 26b, 26c are drain holes penetrating through the connecting rubber elastic body 16 in the vertical direction like the hollow part 26a shown in FIG. 3, which are substantially identical in shape with one another. In addition, the upper ends of the hollow parts 26a, 26b, 26c open onto a portion including the axially innermost part (lowest part) of the upper face 22 of the connecting rubber elastic body 16 in a state of being mounted to the vehicle, which will be described later.

Here, the hollow parts 26a, 26b, 26c are formed at an odd number of locations which are not less than three and are positioned at substantially regular intervals in the circumferential direction of the connecting rubber elastic body 16. In the present embodiment, as shown in FIG. 1, the three hollow parts 26a, 26b, 26c are arranged one by one at three locations positioned at substantially regular intervals in the circumferential direction, away from one another in the circumferential direction. In this embodiment, diametrical lines lₐ, l_{b}, l_{c} (the dot-and-dash lines in FIG. 1) extending in the radial direction of the member mount 10 which pass through the circumferential centers of the three hollow parts 26a, 26b, 26c are substantially at an angle of 120 degrees to each other. Note that the odd number of locations which are not less than three and are positioned at substantially regular intervals in the circumferential direction of the connecting rubber elastic body 16 are not interpreted in a limited manner as locations positioned at exactly regular intervals in the circumferential direction. It would be acceptable as long as the locations fall within a range where they can be found to be at substantially regular intervals. Specifically, the angles between the diametrical lines, which indicate the formation positions of all the hollow parts 26a, 26b, 26c in the connecting rubber elastic body 16, are each allowed to have a gap to an extent of ±10 percent from the set value, for example. In other words, in this embodiment where the three hollow parts 26a, 26b, 26c are arranged at three locations in the circumferential direction, the angles between the diametrical lines lₐ, l_{b}, l_{c} corresponding to the hollow parts 26a, 26b, 26c can be preferably set within the range of approximately 120±12 degrees.

Additionally, the hollow parts 26b, 26c are formed at such locations that, as viewed in the diametrical direction in which the diametrical line lₐ extends, the hollow parts 26b, 26c are away from the hollow part 26a. In the same way, the hollow parts 26c, 26a are formed at such locations that, as viewed in the diametrical direction in which the diametrical line l_{b} extends, the hollow parts 26c, 26a are away from the hollow part 26b. Meanwhile, the hollow parts 26a, 26b are formed at such locations that, as viewed in the diametrical direction in which the diametrical line l_{c} extends, the hollow parts 26a, 26b are away from the hollow part 26c. Note that the projection areas in the respective diametrical directions lₐ, l_{b}, l_{c} corresponding to the hollow parts 26a, 26b, 26c are shown hypothetically using chain double-dashed lines in FIG. 2. As apparent from FIG. 2, the projection area in the direction of lₐ for the hollow part 26a shown by the chain double-dashed lines extends away from the hollow parts 26b, 26c without passing through them. In the same way, the projection area in the direction of l_{b} for the hollow part 26b extends away from the hollow parts 26c, 26a without passing through them. Meanwhile, the projection area in the direction of l_{c} for the hollow part 26c extends away from the hollow parts 26a, 26b without passing through them.

Besides, the hollow part 26a entirely overlaps the inner shaft member 12 as viewed in the diametrical direction in which the diametrical line lₐ extends. In the same way, the hollow part 26b entirely overlaps the inner shaft member 12 as viewed in the diametrical direction in which the diametrical line l_{b} extends. Meanwhile, the hollow part 26c entirely overlaps the inner shaft member 12 as viewed in the diametrical direction in which the diametrical line l_{c} extends. In this embodiment, the width dimension of the hollow part 26a in the direction perpendicular to the diametrical line lₐ is smaller than the width dimension of the inner shaft member 12 in the same direction. In the same way, the width dimension of the hollow part 26b in the direction perpendicular to the diametrical line l_{b} is smaller than the width dimension of the inner shaft member 12 in the same direction. Meanwhile, the width dimension of the hollow part 26c in the direction perpendicular to the diametrical line l_{c}, is smaller than the width dimension of the inner shaft member 12 in the same direction.

Since the three hollow parts 26a, 26b, 26c are arranged as described above, the connecting rubber elastic body 16 has those hollow parts 26a, 26h, 26c as drain holes, while being set with a roughly fixed diametrical spring constant in the circumferential direction. Specifically, when vibration is input in the connecting rubber elastic body 16 in a given diametrical direction, the compression spring component and the tensile spring component act with a substantially fixed ratio, so that a roughly fixed diametrical spring constant is set across the entire circumference of the connecting rubber elastic body 16.

As one example, the spring constant in the left and right direction and the spring constant in the front and back direction are compared for explanation. Specifically, in the left and right direction, as shown in FIG. 1, the hollow part 26a is positioned on the mount center C₁ in the front and back direction. Meanwhile, the hollow parts 26b, 26c are positioned at both front and back sides of the inner shaft member 12 greatly away in the front and back direction, from the mount center C₁ in the front and back direction. Thus, the hollow part 26a reduces the compression spring component comparatively largely, while the hollow parts 26b, 26c have a small effect on the compression spring component. On the other hand, in the front and back direction, the hollow part 26a is arranged in the substantially orthogonal direction to the mount center C₂ in the left and right direction, while the hollow parts 26b, 26c are arranged at locations that deviate to the right side of the mount center C₂ in the left and right direction. Accordingly, the hollow part 26a has few effect on the compression spring component, while the hollow parts 26b, 26c each reduce the compression spring component to a moderate level. As a result, the compression spring component and the shear spring component for the whole mount are substantially the same in the case of input in the left and right direction and in the case of input in the front and back direction. Thus, the spring constant in relation to the vibration input in the left and right direction and that in the front and back direction are substantially the same as each other.

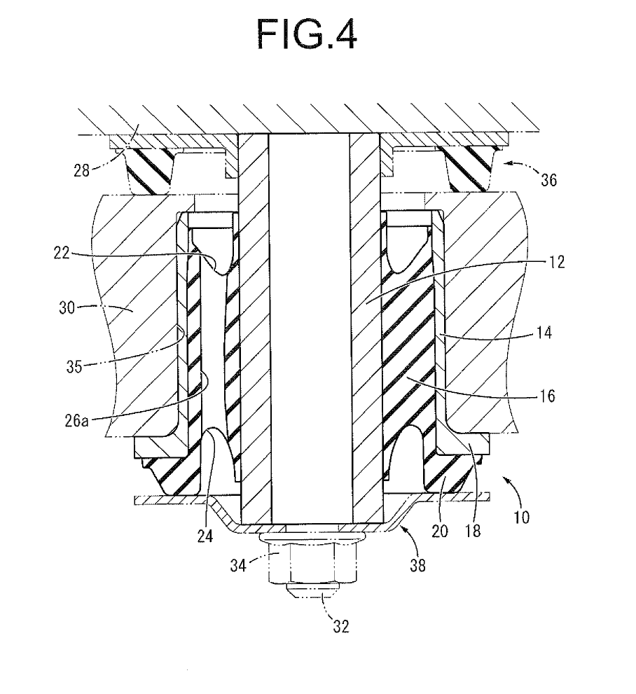

The member mount 10 in such a structure is used in a mounted state wherein the member mount 10 is interposed between a vehicle body 28 and a suspension member 30, as shown in FIG. 4. More specifically, a bolt 32 that protrudes from the side of the vehicle body 28 is inserted through the center hole of the inner shaft member 12 and a nut 34 is screwed in the lower end of the bolt 32, thereby fastening the inner shaft member 12 to the vehicle body 28 with the bolt. On the other hand, the outer tube member 14 is press-fitted into a mounting hole 35 provided in the suspension member 30, so that the outer tube member 14 is press-fitted in and fastened to the suspension member 30. As a result, the member mount 10 is mounted between the vehicle body 28 and the suspension member 30 to connect the vehicle body 28 and the suspension member 30 via the member mount 10 in a vibration-damping manner. In the member mount 10 in use (in the state mounted to the vehicle) shown in FIG. 4, the center axis of the member mount 10, which is the center axis of the inner shaft member 12 and the outer tube member 14 in other words, extends in the vertical direction. However, in the state of the member mount 10 mounted to the vehicle, it is not always necessary that the center axis of the member mount 10 extend in the vertical direction. Provided that the center axis of the member mount 10 is inclined relative to the horizontal direction (the case where the inclination angle is 90 degrees is included), the center axis of the member mount 10 extends in the up and down direction, so that drainage effect described later can be exerted.

Also, in this embodiment, by an upper stopper member 36 to be attached to the upper end of the inner shaft member 12, the suspension member 30 is biased downward. On the other hand, by a lower stopper member 38 to be attached to the lower end of the inner shaft member 12, the outer tube member 14 is biased upward via the stopper rubber 20. As a result, the outer tube member 14 is avoided from slipping out of the suspension member 30, while the upper and lower stopper members 36, 38 constitute stoppers in the vertical direction. Therefore, the elastic deformation amount of the connecting rubber elastic body 16 in relation to the vibration input in the vertical direction is limited to improve the durability of the connecting rubber elastic body 16.

In this state of the member mount 10 being mounted to the vehicle, the diametrical spring of the connecting rubber elastic body 16 is roughly the same across the entire circumference. Accordingly, it is possible to obtain vibration-damping performance and vibration-damping support characteristics of a roughly constant level with respect to a vibration input in a given diametrical direction. Thus, in mounting the member mount 10 to the vehicle, even if the member mount 10 is mounted to the vehicle in a given circumferential orientation, performance variation caused by the difference of the orientation of the member mount 10 is avoided, making it possible to obtain the target performance in a stable manner. Moreover, this facilitates the work to mount the member mount 10 on the vehicle. In addition, there is no possibility that the member mount 10 is oriented toward the wrong direction, whereby a mistake in the work can be avoided.

There is a case where a partial slit or a recessed portion is formed in the stopper rubber 20 for positioning the member mount 10 circumferentially relative to the vehicle. However, a stopper load acts concentratedly on the flange part 18 of the outer tube member 14 in the vicinity of the slit or the recessed portion in the stopper rubber 20. This makes it difficult to apply the idea to the outer tube member 14 formed of the synthetic resin wherein the flange part 18 has a small rigidity. In light of this, in the member mount 10 that does not require to be positioned circumferentially relative to the vehicle, it is easy to use the stopper rubber 20 with an approximately constant cross sectional shape across the entire circumference so as to facilitate formation of the outer tube member 14 with the synthetic resin.

Besides, in the present embodiment, all of the three hollow parts 26a, 26b, 26c are drain holes, which are identical in shape with one another. As a result, each of the hollow parts 26a, 26b, 26c, which are arranged circumferentially at regular intervals, has substantially the same effect on the diametrical spring constant of the connecting rubber elastic body 16. This facilitates to set the diametrical spring constant of the connecting rubber elastic body 16 to have more similar characteristics across the entire circumference.

Furthermore, all of the three hollow parts 26a, 26b, 26c arranged as equally dispersed in the circumferential direction are drain holes. Therefore, it is possible to drain rainwater etc. that builds up in the upper face 22 of the connecting rubber elastic body 16 downward more efficiently through the three hollow parts 26a, 26b, 26c to avoid deterioration of the member mount 10 itself, the suspension member 30 and the like. In addition, since the upper face 22 of the connecting rubber elastic body 16 is a curving surface with the three hollow parts 26a, 26b, 26c formed at locations including the lowest part of the upper face 22 in the mounted state to the vehicle, water etc. can be avoided from remaining in the diametrically inner and outer edges of the connecting rubber elastic body 16 to remove the water etc. efficiently from the upper face 22 of the connecting rubber elastic body 16. Additionally, in this embodiment, the upper face 22 of the connecting rubber elastic body 16 has a shape of a concave groove extending like a circumferential ring with an approximately fixed curving shape. Thus, the water etc. rarely remains between the three hollow parts 26a, 26b, 26c in the circumferential direction, so that the water etc. is leaded into the three hollow parts 26a, 26b, 26c to be drained efficiently.

Also, in this embodiment, the hollow part 26a/26b/26c is formed to have a smaller width dimension than that of the inner shaft member 12 such that, even in an input in the diametrical direction where the hollow part 26a/26b/26c is formed, the connecting rubber elastic body 16 is compressed at the circumferentially opposite sides of the hollow part 26a/26b/26c to exert the compression spring component. This restrains the diametrical spring constant of the connecting rubber elastic body 16 in the formation direction of the hollow part 26a/26b/26c from decreasing in order to obtain a great degree of freedom in tuning the diametrical spring characteristics.

FIG. 5 shows a member mount 40 as a second embodiment of the present invention. The member mount 40 includes five hollow parts 26a to 26e in the circumferential direction as shown in FIG. 5. In the description later, explanations for substantially the same members and parts as those of the first embodiment are omitted by giving the same code numbers in the drawings.

More specifically, the five hollow parts 26a to 26e are formed one by one at five locations positioned at regular intervals in the circumferential direction of the connecting rubber elastic body 16. In FIG. 5, the diametrical lines lₐ to lₑ corresponding to the directions of formation of the respective hollow parts 26a to 26e are shown by dot-and-dash lines. Lines circumferentially next to each other in the diametrical lines lₐ to lₑ make up an angle of about 72 degrees around the center axis of the mount, which is the intersection point of the diametrical lines lₐ to lₑ.

In addition, in FIG. 5, the projection area of the hollow part 26a in the diametrical direction in which the diametrical line lₐ extends is shown with chain double-dashed lines. The diametrical projection area is away from the other four hollow parts 26b, 26c, 26d, 26e. With respect to the other hollow parts 26b/26c/26d/26e, each projection area in the diametrical direction in which the corresponding diametrical line l_{b}/l_{c}/l_{d}/lₑ extends is away from the other four hollow parts 26a, 26c, 26d, 26e/26a, 26b, 26d, 26e/26a, 26b, 26c, 26e/26a, 26b, 26c, 26d in the same way.

This member mount 40 according to the present embodiment exhibits the same effect as that of the member mount 10 of the first embodiment. In short, in the tubular vibration-damping device according to the present invention, the hollow parts 26a, 26b, 26c, . . . will do as long as they are arranged at the odd number of locations which are not less than three and are positioned at regular intervals in the circumferential direction of the connecting rubber elastic body 16, and they are not always limited to be formed at three locations.

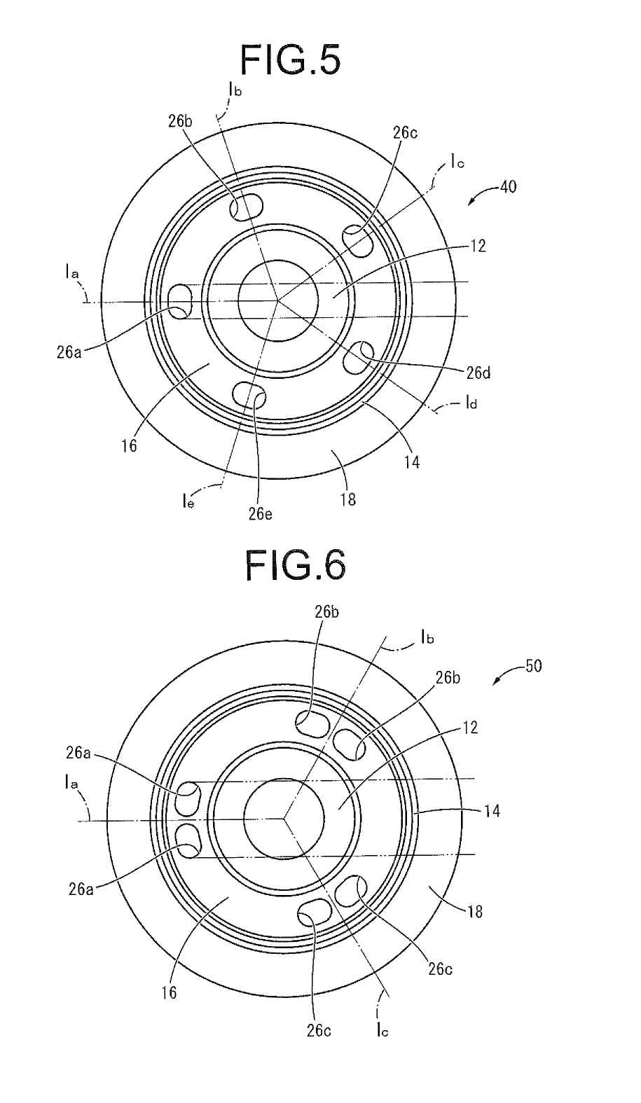

It is also possible to form a plurality of hollow parts at each of the odd number of locations which are not less than three and are positioned at regular intervals in the circumferential direction of the connecting rubber elastic body 16. Specifically, in a member mount 50 as a third embodiment of this invention shown in FIG. 6, two hollow parts 26a, 26a/26b, 26b/26c, 26c are formed at each of three locations positioned at regular intervals in the circumferential direction of the connecting rubber elastic body 16.

In the present embodiment, the hollow parts 26a, 26a, the hollow parts 26b, 26b, and the hollow parts 26c, 26c are formed at three locations in the circumferential direction of the connecting rubber elastic body 16. Besides, the hollow parts 26a, 26a are arranged closer to each other than the hollow part 26b and the hollow part 26c circumferentially next thereto in the circumferential distance so as to constitute a group. In the same way, the hollow parts 26b, 26b are arranged closer to each other than the hollow part 26c and the hollow part 26a circumferentially next thereto in the circumferential distance so as to constitute a group. Meanwhile, the hollow parts 26c, 26c are arranged closer to each other than the hollow part 26a and the hollow part 26b circumferentially next thereto in the circumferential distance so as to constitute a group.

The positions of the hollow parts 26a, 26a/26b, 26b/26c, 26c making up the respective group in the circumferential direction of the connecting rubber elastic body 16 are set by the circumferential center between the hollow parts 26a, 26a/26b, 26b/26c, 26c which constitute the group. In FIG. 6, the diametrical directions (orientations) in which the respective groups of the hollow parts 26a, 26a to 26c, 26c are formed are shown using dot-and-dash lines as the diametrical lines lₐ, l_{b}, l_{c}. Thus, in this embodiment, the diametrical lines lₐ, l_{b}, l_{c} corresponding to the three groups of hollow parts 26a, 26a to 26c, 26c extend in such directions that the lines are at an angle of about 120 degrees to one another.

Moreover, the hollow parts 26a, 26a, the hollow parts 26b, 26b, and the hollow parts 26c, 26c that constitute the respective groups are arranged such that the groups of hollow parts are each away from the other two groups as viewed in the diametrical direction in which the respective corresponding diametrical line lₐ/l_{b}/l_{c} extends. Specifically, the projection area of the hollow parts 26a, 26a in the diametrical direction in which the diametrical line lₐ extends (the area shown by chain double-dashed lines in FIG. 6) is away from the other two groups of the hollow parts 26b, 26b and the hollow parts 26c, 26c. In the same way, the projection area of the hollow parts 26b, 26b in the diametrical direction in which the diametrical line l_{b} extends is away from the other two groups of the hollow parts 26c, 26c and the hollow parts 26a, 26a. Meanwhile, the projection area of the hollow parts 26c, 26c in the diametrical direction in which the diametrical line l_{c} extends is away from the other two groups of the hollow parts 26a, 26a and the hollow parts 26b, 26b.

Thus, even in the case where the plurality of groups of hollow parts 26a, 26a to 26c, 26c are formed in the connecting rubber elastic body 16, the hollow part 26a and the hollow part 26a that constitute a group are arranged closer to each other than to the other hollow parts 26b, 26c in distance, so that the hollow part 26a and the hollow part 26a that constitute the group are arranged at the same location in the circumferential direction of the connecting rubber elastic body 16. In the same way, the hollow part 26b and the hollow part 26b that constitute a group are arranged closer to each other than to the other hollow parts 26c, 26a in distance, at the same location in the circumferential direction of the connecting rubber elastic body 16. Meanwhile, the hollow part 26c and the hollow part 26c that constitute a group are arranged closer to each other than to the other hollow parts 26a, 26b in distance, at the same location in the circumferential direction of the connecting rubber elastic body 16. Accordingly, in the member mount 50 of this embodiment wherein the plurality of hollow parts 26a/26b/26c are arranged at each of the odd number of locations which are not less than three and are positioned at regular intervals in the circumferential direction of the connecting rubber elastic body 16 (three locations in the present embodiment), even by arranging the hollow parts 26a, 26a (26b, 26b/26c, 26c) constituting the group such that they are away from the other hollow parts 26b, 26c (26a, 26c/26a, 26b) as viewed in the diametrical direction, the same effect as those of the first and second embodiments can be obtained.

In the present embodiment, the number of the hollow parts 26a/26b/26c is the same as that of each other group. However, the number of the hollow parts 26a/26b/26c can vary for each group. Moreover, although the hollow parts 26a, 26a/26b, 26b/26c, 26c constituting the respective group have mutually the same shape, it is possible to combine the hollow parts in different shapes to make up a group. Furthermore, the hollow parts 26a, 26a/26b, 26b/26c, 26c constituting the respective group can be arranged side by side in the diametrical direction of the mount.

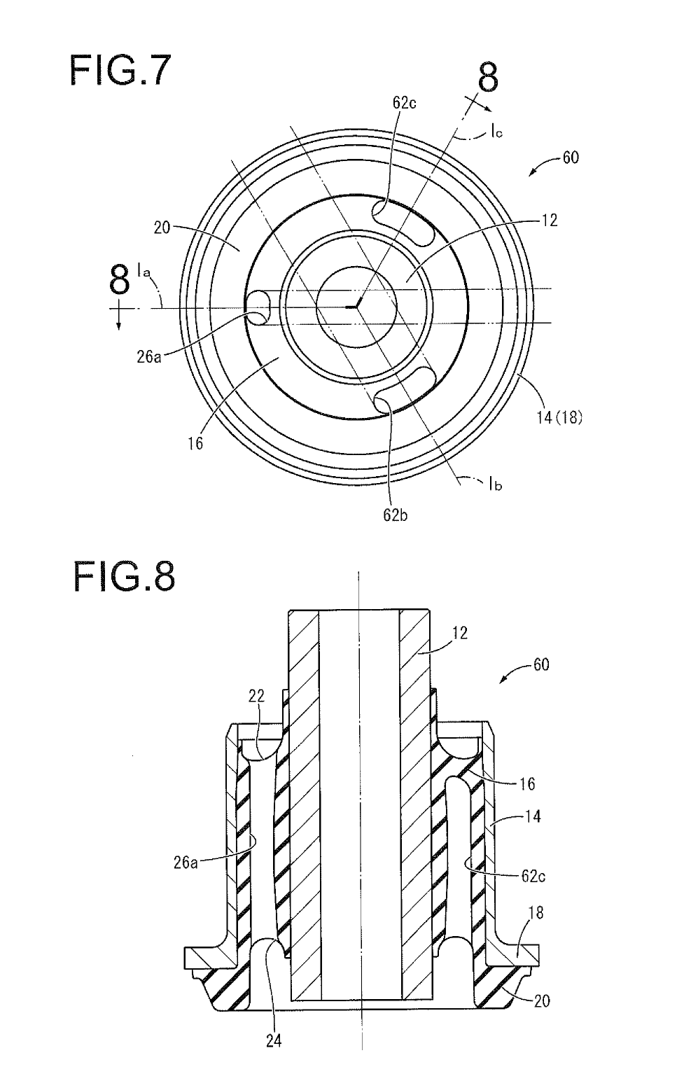

FIGS. 7 and 8 show a member mount 60 as a fourth embodiment of this invention. In the member mount 60, the hollow part 26a as a drain hole and hollow parts 62b, 62c are formed in the connecting rubber elastic body 16.

The hollow parts 62b, 62c are each in a concave shape which opens onto the lower face 24 of the connecting rubber elastic body 16, without opening onto the upper face 22 of the connecting rubber elastic body 16. In short, with respect to the connecting rubber elastic body 16 of the present embodiment, only the hollow part 26a formed at one location in the circumferential direction is a drain hole, while the other hollow parts 62b, 62c do not function as drain holes.

Also, the connecting rubber elastic body 16 is thin in the vertical direction at the portions where the hollow parts 62b, 62c are formed, with a small diametrical spring constant. In the present embodiment, the circumferential length for the hollow parts 62b, 62c in concave shapes is greater than that of the hollow part 26a, which is a through hole, thereby adjusting the diametrical spring constant of the connecting rubber elastic body 16. The circumferential lengths of the hollow parts 62b, 62c and the circumferential length of the hollow part 26a are set as appropriate, considering the ratio of the depth dimension for the hollow parts 62b, 62c to the axial dimension of the connecting rubber elastic body 16 and the like, such that the circumferential variation of the diametrical spring constant of the connecting rubber elastic body 16 is small enough.

Although the depth dimension for the hollow parts 62b, 62c is not especially limited, in preferred practice, the depth dimension is a half of the axial dimension of the connecting rubber elastic body 16 or larger. Besides, the portions of the connecting rubber elastic body 16 constituting the upper base walls of the hollow parts 62b, 62c are preferably thin to such an extent that the effect that the portions of the connecting rubber elastic body 16 have on the diametrical spring constant is small enough.

The hollow parts 26a, 62b, 62c are formed at three locations positioned at regular intervals relative to one another in the circumferential direction. In FIG. 7, diametrical lines lₐ, l_{b}, l_{c} passing through the circumferential centers of the hollow parts 26a, 62b, 62c are illustrated using dot-and-dash lines. Such diametrical lines lₐ, l_{b}, l_{c} are at an angle of approximately 120 degrees to each other around the center axis of the mount, which is the intersection point thereof. In this embodiment, the hollow part 26a and the hollow parts 62b, 62c which are mutually different in the circumferential length are arranged at three locations such that all the circumferential centers are positioned at regular intervals in the circumferential direction of the connecting rubber elastic body 16. The circumferential intervals between the hollow parts 26a, 62b, 62c are not equal.

The hollow parts 62b, 62c are arranged at positions away from the diametrical projection area of the hollow part 26a (the area shown by chain double-dashed lines in FIG. 7). In the same way, the hollow parts 62c, 26a are arranged at positions away from the diametrical projection area of the hollow part 62b (the area shown by chain double-dashed lines in FIG. 7), while the hollow parts 26a, 62b are arranged at positions away from the diametrical projection area of the hollow part 62c.

In the member mount 60 in a structure according to the present embodiment like this, the same effect as those of the first to third embodiments can be obtained. In short, not all the hollow parts are required to be through holes and function as drain holes. It is also possible to form the hollow parts 62b, 62c in concave shapes, for reducing or eliminating the circumferential anisotropy of the diametrical spring constant of the connecting rubber elastic body 16 caused by formation of the hollow part 26a as a drain hole.

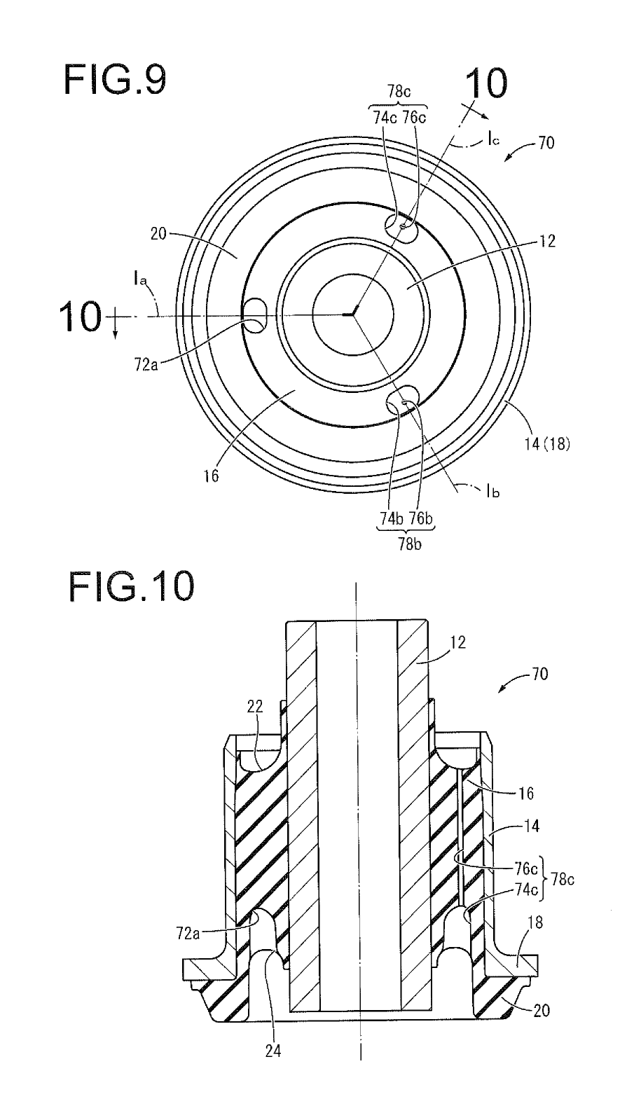

FIGS. 9 and 10 show a member mount 70 as a fifth embodiment of the present invention. In the member mount 70, a hollow part 72a and concave parts 74b, 74c are formed in the connecting rubber elastic body 16.

The hollow part 72a is a concavity opening onto the lower face 24 of the connecting rubber elastic body 16, which is formed with a depth dimension smaller than a half of the axial dimension of the connecting rubber elastic body 16 in this embodiment. The concave parts 74b, 74c are concavities opening onto the lower face 24 of the connecting rubber elastic body 16, which are formed with depth dimensions smaller than a half of the axial dimension of the connecting rubber elastic body 16 in this embodiment. Note that the concave parts 74b, 74c are formed at different positions in the circumferential direction with mutually and substantially the same shape. On the other hand, the hollow part 72a and the concave parts 74b, 74c are formed at different positions in the circumferential direction with shapes different but similar to each other.

In addition, a through hole 76b is formed in the portion of the connecting rubber elastic body 16 constituting the upper base wall of the concave part 74b, while a through hole 76c is formed in the portion of the connecting rubber elastic body 16 constituting the upper base wall of the concave part 74c. The through holes 76b, 76c extend vertically with cross sectional shapes smaller enough than those of the openings of the concave parts 74b, 74c, to open onto the upper base faces of the concave parts 74b, 74c, respectively and the upper face 22 of the connecting rubber elastic body 16. In this way, the concave parts 74b, 74c and the through holes 76b, 76c are formed in series vertically and continuously, whereby those concave parts 74b, 74c and the through holes 76b, 76c constitute hollow parts 78b, 78c penetrating through the connecting rubber elastic body 16 in the vertical direction. In this embodiment, the concave part 74b and the through hole 76b form the hollow part 78b, while the concave part 74c and the through hole 76c form the hollow part 78c, so that the member mount 70 is provided with two drain holes as the hollow parts 78b, 78c.

In the present embodiment, since the through holes 76b, 76c have a small effect on the diametrical spring constant of the connecting rubber elastic body 16 owing to their small cross sectional shapes, the hollow part 72a and the concave parts 74b, 74c are made to have similar shapes. However, at least one of the depth and the transverse cross sectional area of the hollow part 72a is made greater than those of the concave parts 74b, 74c in order to adjust the diametrical spring constant of the connecting rubber elastic body 16 to be approximately definite across the entire circumference.

This member mount 70 in a structure according to this embodiment can have a drainage function, while having a small circumferential variation in the diametrical spring constant of the connecting rubber elastic body 16, as well as each aforesaid embodiment.

In the present embodiment, the concave part 74b/74c is a concavity that opens onto the lower face 24 of the connecting rubber elastic body 16. However, the through hole can be formed vertically penetrating through the base wall part (lower wall part) of the concave part opening onto the upper face 22 of the connecting rubber elastic body 16 so as to form the drain hole (hollow part), for example. Also, it is possible to form each the concave part opening onto the lower face 24 of the connecting rubber elastic body 16 and the concave part opening onto the upper face 22 thereof and form the through hole penetrating through the connecting rubber elastic body 16 between the concave parts in the vertical direction for providing the drain hole.

Although the embodiments of the present invention have been described above, the present invention is not limited by the specific description. For example, the shape of the hollow part in bottom view is not always limited to the shape extending in the circumferential direction. The shape can be such a circle that the center of curvature is inside the hollow part for the whole circumferential wall face of the hollow part.

In the above-described embodiment, the drainage of the rainwater etc. by the drain hole in a state of the tubular vibration-damping device mounted to the vehicle is illustrated as an example. However, a liquid is discharged (drained) downward owing to the drain hole even in the tubular vibration-damping device before being mounted to the vehicle, for example in the case where it rains over the tubular vibration-damping device being carried or stored, or in the case the liquid is spilled over it in the manufacturing process thereof. Furthermore, the liquid discharged via the drain hole is not always limited to water. For example, in the case where the manufacturing process includes a step of soaking the tubular vibration-damping device in a rustproofing liquid etc., extra liquid can be discharged via the drain hole.

Additionally, the tubular vibration-damping device according to this invention can be applied not only to an automotive member mount, but also to an engine mount, a differential mount, a dynamic damper, a suspension bushing and the like. Moreover, the application range of the present invention is not limited to a tubular vibration-damping device for a vehicle, and the invention can be applied to a tubular vibration-damping device used for a motorcycle, a vehicle for railway, an industrial vehicle or the like, for example.

What is claimed is:

1. A tubular vibration-damping device comprising:
an inner shaft member extending in a vertical direction;
an outer tube member arranged so as to be externally about the inner shaft member;
a connecting rubber elastic body elastically connecting the inner shaft member and the outer tube member with each other; and
a plurality of hollow parts formed in the connecting rubber elastic body so as to open onto an axially lower face thereof, at least one of the hollow parts being a drain hole penetrating through the connecting rubber elastic body in the vertical direction, wherein
the hollow parts are formed at an odd number of locations which are not less than three and are positioned at regular intervals in a circumferential direction of the connecting rubber elastic body, and
the hollow parts are arranged so as not to overlap one another as viewed in a diametrical direction of the outer tube member.

2. The tubular vibration-damping device according to claim 1, wherein an axially upper face of the connecting rubber elastic body is a curving surface that extends with a concave cross section in the circumferential direction, and the drain hole opens onto a portion including an axially innermost part of the upper face of the connecting rubber elastic body.

3. The tubular vibration-damping device according to claim 1, wherein the hollow parts entirely overlap the inner shaft member as viewed in the diametrical direction.

4. The tubular vibration-damping device according to claim 1, wherein all of the hollow parts are the drain holes penetrating through the connecting rubber elastic body in the vertical direction.

5. The tubular vibration-damping device according to claim 4, wherein the drain holes are identical in shape with one another.

6. The tubular vibration-damping device according to claim 1, wherein the hollow parts are formed one by one at three locations positioned at regular intervals in the circumferential direction of the connecting rubber elastic body.
